(19) United States
(12) Patent Application Publication
(10) Pub. No.: US 2017/0277272 A1
(43) Pub. Date: Sep. 28, 2017

(54) INFORMATION DISPLAY DEVICE

(71) Applicant: SCA Hygiene Products AB, Göteborg (SE)

(72) Inventor: Magnus NORDIN, Göteborg (SE)

(73) Assignee: SCA Hygiene Products AB, Göteborg (SE)

(21) Appl. No.: 15/510,707

(22) PCT Filed: Sep. 16, 2014
(86) PCT No.: PCT/EP2014/069726

§ 371 Date: Mar. 13, 2017

(51) Int. Cl. G06F 3/01; G06F 3/16; A47K 17/00; H04B 10/50

(52) U.S. Cl. CPC G06F 3/017; H04B 10/502; G06F 3/167; A47K 17/00

(57) ABSTRACT

An information display device including a display displays content for conveying content to a user configured to adapt the content conveyed to the user by changing the content displayed on the display based on a received or determined detection result.

### CROSS-REFERENCE TO PRIOR APPLICATION

This application is a § 371 National Stage Application of PCT International Application No. PCT/EP2014/069726 filed Sep. 16, 2014, which is incorporated herein in its entirety.

### TECHNICAL FIELD

The present disclosure relates to an information display device including display means to display content, and, with this, to convey a corresponding content to a user. The present disclosure particularly relates to information display devices that are employed in conjunction with hygienic service facilities, including, for example, toilets, urinals, sinks, dispensers, and the like. The present disclosure also relates to a system for conveying content to a user, and corresponding methods.

### BACKGROUND

Information display devices already find broad application in various fields. Commonly, information display devices are employed for conveying content to users in some form of specific or non-specific environment like train stations, airports, toilets, restroom facilities, etc. Related installations make use of various kinds of information display devices in order to convey any sort of information to the users of the facilities.

In general, the mentioned environments may either be accessible by the public or only by a somewhat limited number of users, for example in the case of facilities operated by an authority, a company, or other type of owner. In the latter cases, typical environments include office buildings, restaurants, stadia, event venues, and the like.

Common to the above mentioned environments is that usually a more or less large number of users have access to the facilities and are thus correspondingly served by the installed information display devices. Especially in the context of hygienic service facilities, such as toilets and the like, the users of the information display devices installed in such a facility can be also identified as the users of the facility as such. For example, the employed information display devices may convey content with regard to the cleaning state or occupancy state of hygienic facilities, or may also convey information of some other sort, including advertisements, flight-, train- or travel-information, etc.

In general, conventional information display devices are usually restricted to convey content only in the direction toward the users in some kind of one-way configuration. Specifically, most conventional information devices installed in public and non-public environments can only display content and do not accept any input from the user with regard to changing the display content and, more specifically, requesting particular information.

However, there are also known information display devices that allow for interaction with the users by means of allowing a user to input a command to the device. These input means usually include touch screens, track balls, keyboards, and the like. Common to these types of input means is that the users are usually required to touch parts of the device as, for example, the screen surface, the keys, or the track ball.

However, in some environments interaction of a user with an information display device is so far limited due to various reasons. Especially in the context of hygienic facilities, users may be reluctant to interact with information display devices due to hygienic concerns. For example, they may be afraid of picking up disease spreading bacteria when no sufficient hygienic/disinfection measures are taken.

At the same time, there are already known information display devices in such environment that rely on an interaction with the user so that he or she can enter information or select options. Specifically, it is known to provide an information display device in the vicinity of a restroom, where a user can leave a feedback regarding the hygienic and cleanliness state of the facility used. For example, one or more buttons or symbols (plus and minus signs, smileys, etc.) are displayed so that the user can simply touch one of the symbols in order to leave a corresponding feedback.

However, and especially in the context with hygienic service facilities, users usually tend to touch as few as possible objects in a restroom for the above mentioned reasons. In turn, this may yield an unsatisfactory acceptance of such information display devices. As a consequence, the efficiency of user interaction systems may be drastically diminished, when users actually avoid using them.

There is therefore a need for an improved information display device that not only conveys content to a user, but also allows interaction with the user without the need to physically touch parts of the device. At the same time, the solution should be practicable in the sense of minimizing the required employment of technology so that already existing equipment should be exploited as much as possible.

### SUMMARY

According to an embodiment, there is provided an information display device including display means to display content for conveying said content to a user and including communication means to at least receive data from a network, the information display device being configured to emit an optical signal, to receive, from said network, a detection result indicating the detection of the signal by an external device, and to adapt the content conveyed to said user by changing the content displayed on said display means based on the received detection result.

According to another embodiment, there is provided an information display device including display means to display content for conveying said content to a user and including detection means to detect a visual, acoustic and/or gesture instruction from said user, the information display device being configured to determine a detection result indicating an instruction from said user, and to adapt the content conveyed to said user by changing the content displayed on said display means based on the determined detection result.

According to another embodiment, there is provided a system for conveying content to a user, including an information display device according to a related embodiment, a network entity, and an external device, wherein an application on said external device is configured to generate the detection result in response to detecting one of said signals and to forward said detection result to said network entity via a wireless communication network.

According to another embodiment, there is provided a method for displaying content for conveying said content to a user, the method including a step of emitting an optical signal from an information display device including display means; a step of receiving, from a network, a detection result indicating the detection of the signal by an external device; and a step of adapting the content conveyed to said user by changing the content displayed on said display means based on the received detection result.

According to another embodiment, there is provided a method for displaying content for conveying said content to a user, the method including a step of detecting a visual, acoustic and/or gesture instruction from said user; a step of determining a detection result indicating said instruction from said user; and a step of adapting the content conveyed to said user by changing the content displayed on said display means based on the determined detection result.

### BRIEF DESCRIPTION OF THE DRAWINGS

Embodiments of the present invention, which are presented for better understanding the inventive concepts and which are not to be seen as limiting the invention, will now be described with reference to the figures in which:

FIGS. 1A and 1B show schematic views of overall system configurations;

FIG. 2 shows a schematic view of a network entity;

FIGS. 3A to 3E show schematic views of information display devices;

FIG. 4 shows a schematic view of an alternative overall system configuration;

FIGS. 5A and 5B show schematic views of further information display devices;

FIGS. 6A and 6B show schematic views of information display devices being part of a hygienic service facility; and

FIGS. 7A and 7B show flow charts of general method embodiments.

### DETAILED DESCRIPTION OF PARTICULAR EMBODIMENTS

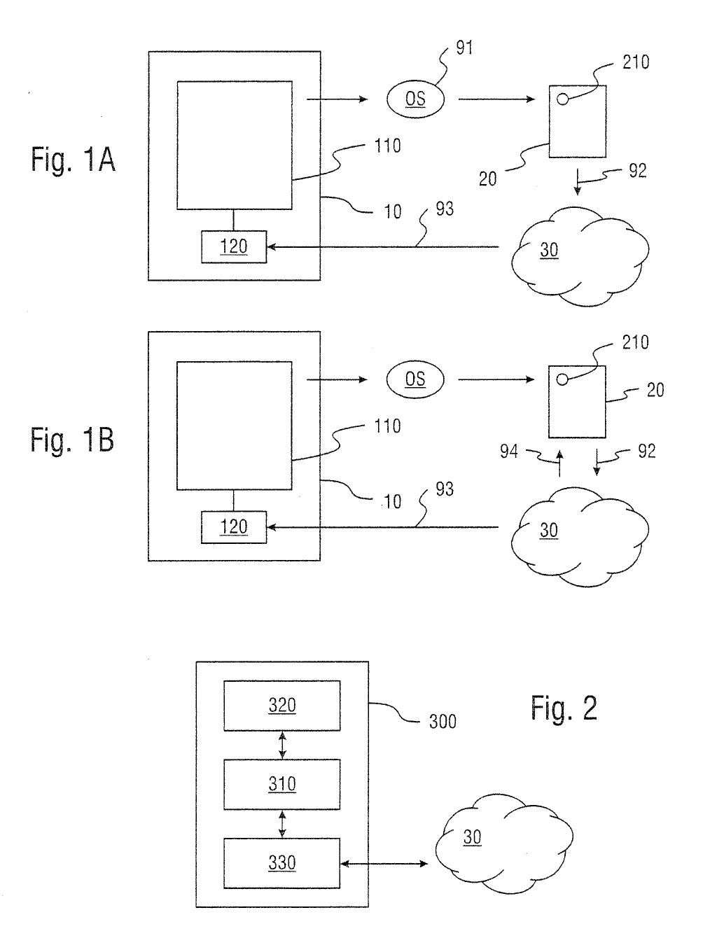

FIG. 1A shows a schematic view of an overall system configuration according to an embodiment. Specifically, the present embodiment considers an information display device 10 that includes display means 110 and communication means 120. The display means 110 are adapted to display content for conveying said content to a user. Communication means 120 are adapted to at least receive data 93 from a network 30 and to control the display means 110, the latter in particular with regard to the content displayed.

The information display device 10 is further configured to emit an optical signal (OS) 91 that can be detected by an external device 20. For this purpose, the external device 20 includes detection means 210 in the form of, for example, a light sensor, a scanner, a camera, a CCD camera, a CMOS camera, or the like. Specifically, the external device 20 may be in the form of a smartphone, a personal digital assistant (PDA), or a handheld or tablet computer. Especially smartphones and tablet computers usually include a built-in digital camera that is suitable for acquiring digital image data from an optical target.

If accordingly directed, the external device 20 can thus detect the optical signal 91 from the information display device 10. The external device 20 can be further adapted to generate a detection result upon detecting the optical signal 91 emitted from the information display device 10. This may be effected by means of an application (so-called “app”) that is installed and runs on the external device 20. The application will be in the form of a program that instructs the processing means of the external device 20 so as to, amongst others, acquire and process data from the detection means 210 for generating the respective detection result. For this purpose, said processing may include functions of pattern recognition, decoding of one- or two-dimensional barcodes, or, in general, image processing. The external device 20 can then forward the detection result in the form of a notification 92 to the network 30.

On the side of the network 30, the notification 92 can be further handled and processed so as to generate an instruction 93, which is, in turn, sent to the communication means 120 of the information display device 10. In a particular embodiment, the optical signal 91 carries information that identifies (or is suitable for identifying) the particular information display device 10 that has emitted the detected signal 91. In such an embodiment, the notification 92 can convey this information on identifying the device 10 to the network 30, where it can be determined which particular information display device 10 has emitted the signal 91 and possibly also which external device 20 (user) detected the signal 91. In general, the network side 30 can decide where the instruction 93 is to be sent by means of correspondingly addressing instruction 93. For example, a particular notification 92 is received on the network side 30 where an instruction 93 is addressed to the correct information display device 10 and sent to the same. As a consequence, instruction 93 will be—even if only indirectly—also a form of the detection result determined earlier.

Upon receiving instruction 93, the information display device 10 is configured to adapt the content displayed on the display means 110. In particular, the information display device 10 changes the content on the display means 110 in reaction to receiving instruction 93. In this way, a closed loop is obtained between the information display device 10 on the one side and an external device 20 on the other: Firstly, the information display device 10 emits an optical signal 91 that is received and detected by external device 20. The external device 20 then generates notification 92 as a form of the detection result 92 and forwards this to a network 30. From this network 30, a further notification (instruction) is then sent to the information display device 10, thereby closing a feedback loop. This loop allows for control of and interaction with the information display device 10 without the need for touching it.

FIG. 1B shows a schematic view of an alternative overall system configuration according to another embodiment. In principal, the present configuration considers the same elements as described in conjunction with FIG. 1A so as to implement a closed loop of information between the information display device 10 and the external device 20. However, the alternative system configuration considers an additional sending of information 94 from the network side 30 toward the external device.

In this way, an additional content may be rendered on external device 20 in response to the detection result. For example, a “thank you” message may be conveyed by information 94 for giving the user a feedback on using the system. Additionally or alternatively, information 94 may result in rendering same or similar content on external device 20 as compared to the changed content being displayed on device 10 in response to receiving the detection result. In this way, the user can advantageously continue consuming (reading, watching, listening to, etc.) the adapted content even if moving away from information display device 10.

FIG. 2 shows a schematic view of a network entity according to another embodiment. In general, the network entity 300 can be in the form of an application running on hardware that is shared by one or more further applications and tasks within the network 30. Usually, network tasks are implemented in the form of individual programs running on processing equipment connected to a network or being part of the network infrastructure as such. However, the network entity may be likewise identified as a piece of hardware where the above program is executed. In this way, the network entity 300 may be implemented by means of processing resources 310, memory resources 320, and communication resources 330. These resources 310, 320 and 330 may be shared resources by means of which other tasks and applications can be implemented on the same hardware. In a particular embodiment, a server hardware includes the resources 310, 320 and 330 for implementing the network entity 300.

In general, the memory resources 320 store code that instruct the processing means 310 and communication means 330 so as to implement corresponding embodiments. Specifically, the memory means 310 include code to implement the reception of notification 92, to determine the target display device 10, and to generate and forward the instruction 93 to the determined (and correct) target information display device 10. Optionally, also information 94 may be generated and sent to the external device 20 which is the originator of the information 92. Both instruction 93 and/or information 94 may include information on adapted content to be rendered on information display device 10 and/or external device 20. This information on content (or adapted content as such) may be stored in memory means 320 or may be well retrieved also from other sources via communication means 330 and network 30.

In general, network 30 represents a collection of conventional networks, such as the Internet, cellular communication networks (eg. GSM, GPRS, Edge, 3GGP, LTE and the like), local or wide area networks (LAN or WAN) or their respective wireless implementations (eg. WLAN, WiFi, WiMax, etc.). In one specific implementation, the notification 92 is conveyed from the external device 20 via a cellular communication network to the Internet. The Internet then conveys the information to the network entity 300 connected to the Internet. Any information from there is then again conveyed via the Internet toward the information display device 10 and/or the external device 20. The last part for conveying instruction 93 to the device 10 may then be again a cellular communication network or a further wireless or wirebound local area network (LAN or WLAN).

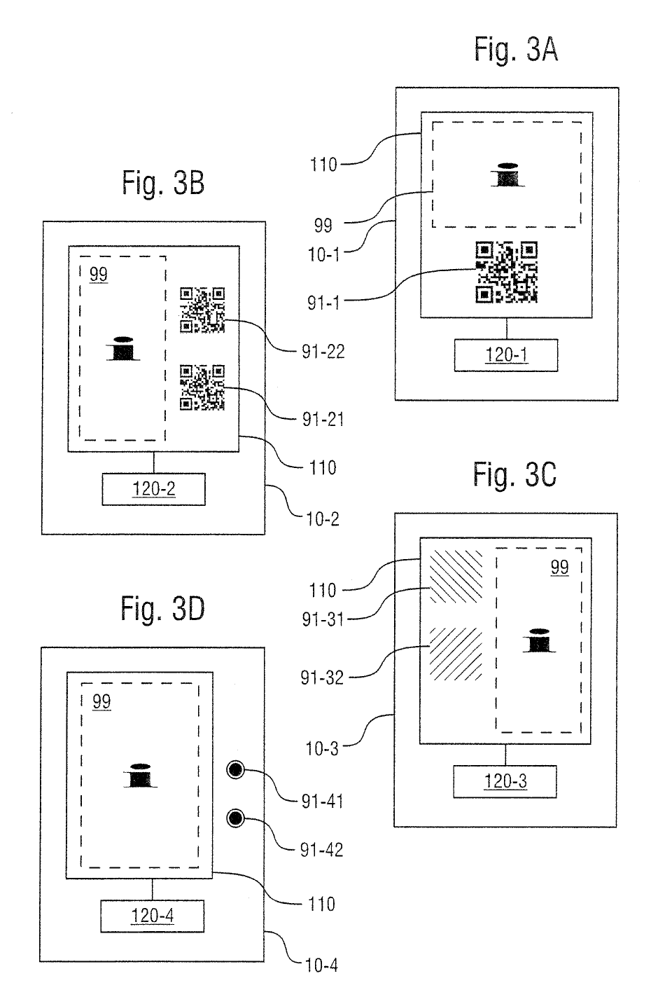

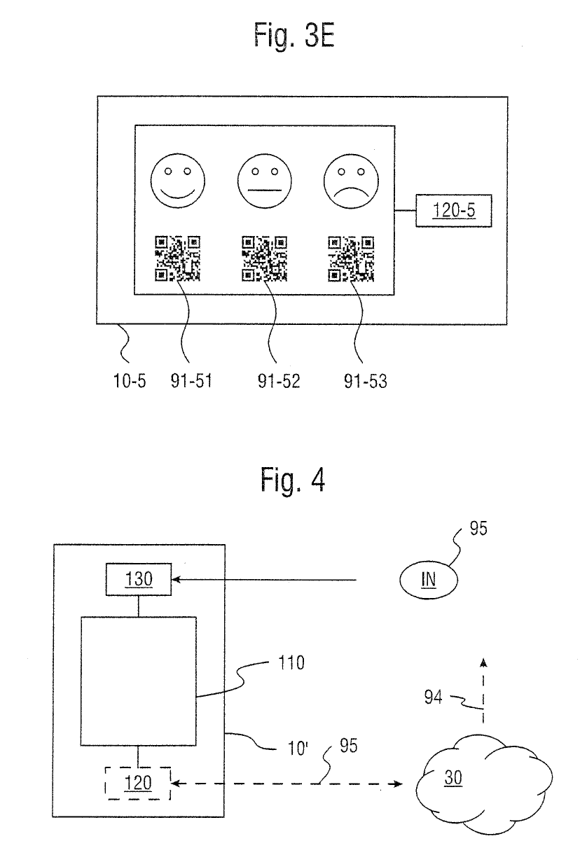

FIG. 3A shows a schematic view of a first information display device 10-1 according to another embodiment. This information display device 10-1 includes display means 110 for displaying content to be conveyed to a user. This content may include information 99 including any one of graphical, image, text, and video content. The information 99 may include general information to the user, instructions to the user, advertisements, flight or train departure/arrival, or general travel information. While travel information will be most likely on the form of text, advertisements will usually include graphical, image, video and/or audio content.

According to this embodiment, the display means 110 also display a barcode or QR-code 91-1 as one form of the emitted optical signal. In this way, an optical signal is emitted from the display means 110 that can be recorded/detected by an external device 20 and can at the same time also convey additional information (payload). For example, a smartphone or tablet computer including a digital camera can detect the emitted optical signal by decoding the barcode 91-1. The display control and communication means 120-1 are configured to display content 99 and barcode 91-1 on display means 100 and to adapt content 99 in response to receiving a detection result (instruction) from a network side. The instruction is generated and transmitted in response to detecting the barcode 91-1 by an external device. Said means 120-1 may include memory resources for storing alternative content for changing the content displayed on the display means 110 or, additionally or alternatively, may receive adapted/changed content information from the network side.

FIG. 3B shows a second information display device 10-2 according to another embodiment. According to this embodiment, display means 110 again display content in the form of the above-discussed information 99, and, at the same time, display two or more different barcodes 91-21, 91-22. The two or more different barcodes represent two different optical signals emitted from display means 110. In this way, a user can select one of the different barcodes and can accordingly direct his/her external device 20 so as to detect the corresponding barcode. In this way, alternative information on detecting a specific optical signal from one information display device can be forwarded to the network side, and, correspondingly, the network side and/or the information display device as such may change and adapt the displayed content in accordance with the detection of a specific signal.

In other words, alternatives are provided to the user who can then not only change the content, but also select a specific content to be rendered on display means 100 of information display device 10-2. For example, the user can choose alternative advertisements, information, videos or the like according to his/her needs. As a more specific example, the user can choose a specific product field and can therefore be provided with corresponding advertisements in the specific field of interest during the use of the hygienic service facility. Further, the user can select specific information, for example either departure time information or arrival time information, and can therefore use the time that he/she spends with the hygienic service facility for obtaining the information of actual interest. In all, the display efficiency can be substantially improved and the user satisfaction greatly enhanced.

FIG. 3C shows a third information display device according to another embodiment. Information display device 10-3 includes display means 110 that again displays content in the form of the above-discussed information 99. Further, display means 110 displays two different optical signals in the form of different patterns 91-31 and 91-32. These patterns may include other forms and formats of two-dimensional barcodes, QR-codes, one-dimensional barcodes, hidden patterns, or time varying patterns. As far as the latter two are concerned, patterns can be employed that are as such not visible or distinguishable to the human eye. For example, the emission of light inside the patterns 91-91 and 91-32 may vary with a speed that is not recognizable by the human eye. At the same time, such modulation of light can be employed to convey and encode information in the corresponding optical signal.

FIG. 3D shows a fourth information display device according to another embodiment. Information display device 10-4 includes dedicated emission means 91-41 and 91-42 for emitting one or more optical signal(s). These means may be in the form of light sources (e.g. LEDs, and the like) that emit an optical signal in the form of a timely varying intensity pattern. Directing again an external device at the corresponding signal source allows for detecting the same and if two or more distinguishable signals are emitted, the selection of a specific option.

In general, the content displayed by any information display device may include information that describes the significance of a specific optical signal. For example, the information can include captions for each emitted signal (displayed pattern, barcode). If there are options, i.e. more than one signals emitted, there can be corresponding captions in the vicinity of the barcode, pattern, or signal source. These captions can indicate which information/content will be displayed on display means 110 in response to detecting the corresponding optical signal.

FIG. 3E shows a fifth display device according to another embodiment. According to this embodiment, the information display device 10-5 implements a feedback device that allows a user to leave feedback, which concerns, for example, the general state of a hygienic facility. Three different icons are displayed as content for conveying information to a user, wherein each one of the three displayed barcodes 91-51, 91-52, 91-53 is then associated with a specific state of satisfaction or some condition.

Usually, states of satisfaction are “universally” indicated by means of so-called “smileys” that convey one or more different states of satisfaction independent from language or reading capabilities. The user can accordingly direct his/her external device to the corresponding barcode 91-51, 91-52, or 91-53 in accordance with the feedback. In response to receiving and processing the corresponding detection result, the information display device 10-5 may change/adapt the content displayed so as to demonstrate to the user the acknowledgment of receipt of the respective feedback. The user can be in this way informed that his/her feedback has been recorded.

FIG. 4 shows a schematic view of an alternative overall system configuration according to a further embodiment. In general, display means 110 and (optional) communication means 120 of the information display device 10′ are similar to those described in conjunction with other embodiments. This alternative, however, considers that the information display device 10′ includes detection means 130 for detecting an instruction 95 from a user. In response to receiving instruction 95, information display device 10′ generates a detection result for adapting the contents to be displayed on display means 110 as discussed and explained in conjunction with other embodiments.

Specifically, detection means 130 may include any one of a digital camera, a CCD camera, a gesture camera, a motion detector, an ultrasonic detector, an infrared (IR) detector, a microphone, a voice detector, and the like. In this way, detection means 130 may be adapted to receive a visual, acoustic and/or gesture instruction from a user. The content displayed on display means 110 may be changed/adapted according to a corresponding detection result generated in conjunction with receiving (and successfully decoding) an instruction from a user.

As regards the recognition and processing of the instruction 95, detection means 130, communication means 120, or other parts of the information display device 10′ may comprise include processing resources for processing a raw signal (or: raw data) retrieved from a camera, light detector, and/or microphone. This raw data is processed and analyzed for determining a corresponding detection result. Dependent on the kind of instruction, said processing may involve image processing, gesture detection, and or voice decoding for generating a corresponding detection result.

As in other embodiments, also a plurality of different detection results may be considered in that the instruction 95 can provide alternative inputs to the information display device 10′. The optional communication means 120 of information display device 10′ are optional in the sense that no communication to an external network 30 is necessary for detecting and processing the instruction 95 and for accordingly changing the content rendered on display means 110. However, the provision of communication means 120 may allow exchange of information 95 with a network 30 in order to, for example, acquire adapted content from network 30 and/or forwarding information 94 to a user (i.e. to a user's external device, e.g. smartphone) via network 30.

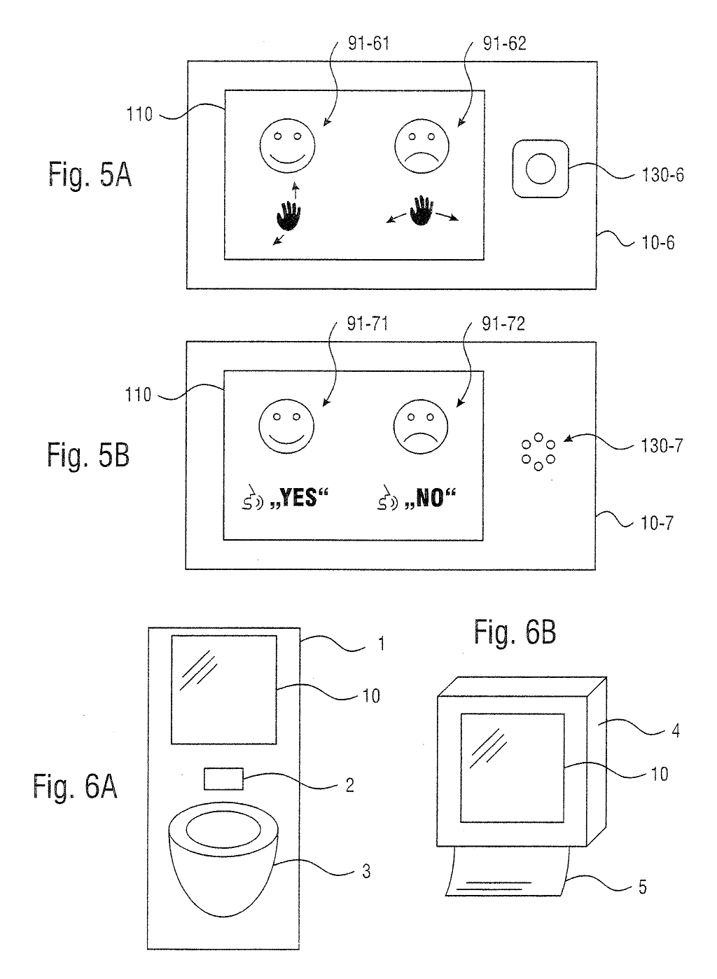

FIG. 5A shows a schematic view of a sixth information display device according to a further embodiment. Information display device 10-6 includes detection means 130-6 in the form of, for example, a digital camera and/or a motion detector. Information 91-61, 91-62 is displayed on display means 110 for conveying content to a user of the information display device 10-6. In the present embodiment, alternative inputs are provided to the user in that two distinguishable gestures are presented to the user. Each gesture is associated to a specific input so that a distinguishable gesture is associated to a corresponding state of satisfaction. More particularly, content 91-61 conveys to a user that waving a hand vertically corresponds to leaving a positive feedback, whereas content 91-62 conveys to the user that waving a hand horizontally leaves negative feedback.

FIG. 5B shows a schematic view of a seventh information display device according to a further embodiment. Information display device 10-7 includes detection means 130-7 in the form of, for example, a microphone and/or a sound detector. Information 91-71, 91-72 is displayed on display means 110 for conveying content to a user of the information display device 10-7. In the present embodiment, alternative inputs are again provided to the user in that two acoustic instructions are presented to the user. Each acoustic instruction is again associated to a specific input so that a distinguishable instruction is associated to a corresponding state of satisfaction. More particularly, content 91-71 conveys to a user that saying “yes” corresponds to leaving a positive feedback, whereas content 91-72 conveys to the user that saying “no” leaves negative feedback.

In general, communication and control means 120-1, 120-2, 120-3, 120-4, 120-5, 120-6, and 120-7 implement corresponding control and result reception according to the respective embodiment as described for each information display device 10-1, 10-2, 10-3, 10-4, 10-5, 10-6, and 10-7.

FIG. 6A shows a schematic view of a hygienic service facility according to another embodiment. In this embodiment, an installation 1 comprises a urinal 3, urinal control means 2, and an information display device 10 in the form of one of the information display devices described in conjunction with the embodiments. It can be a specific advantage of the installation 1 that the user of the urinal 3 is exposed to the content displayed on the display means of information display device 10 for the time of using urinal 3. The control means 2 may be implemented so as to control flushing the urinal 3, cleaning the urinal 3, and/or interacting with the information display device 10 so as to initiate or stop operation.

For example, control means 2 may include a proximity sensor that is adapted to sense the proximity of a user of urinal 3. For energy saving considerations or the like, detecting the proximity of a user may initiate displaying contents and emitting one or more optical signals by the information display device 10. The contents is then later adapted/changed in accordance with receiving a detection result as described in conjunction with the other embodiments. In any way, the present embodiment can likewise be modified to other types of hygienic service facilities, such as a toilet seat and corresponding flushing and/or cleaning equipment. Such further embodiments may consider placing the display means and information display device 10 on the opposite side so that the user of the hygienic service facility can see and observe and correspondingly operate the information display device while using the hygienic service facility.

FIG. 6B shows a further hygienic service facility according to another embodiment. Specifically, it is shown a towel dispenser 4 for dispensing hand towels 5. On the front side of dispenser 4, there is arranged the display means of an information display device as described in conjunction with one or more of the other embodiments. It is to be noted that this embodiment relating to a towel dispenser can be likewise modified to other dispensers known and common in the field of hygienic service facilities. In particular, it can be modified for soap dispensers, liquid dispensers, alcogel dispenser, disinfection liquid dispensers, and the like.

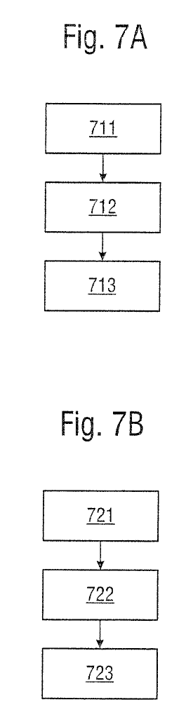

FIG. 7A shows a flow chart of a general method embodiment. According to this embodiment, there is provided a method for displaying content for conveying said content to a user, the method including a step 711 of emitting an optical signal from an information display device including display means; a step 712 of receiving, from a network, a detection result indicating the detection of the signal by an external device; and a step 713 of adapting the content conveyed to said user by changing the content displayed on said display means based on the received detection result.

FIG. 7B shows a flow chart of another general method embodiment. According to another embodiment, there is provided a method for displaying content for conveying said content to a user, the method including a step 721 of detecting a visual, acoustic and/or gesture instruction from said user; a step 722 of determining a detection result indicating said instruction from said user; and a step 723 of adapting the content conveyed to said user by changing the content displayed on said display means based on the determined detection result. The general method embodiments can be adapted so as to include additional steps for implementing an information display device or system as disclosed in conjunction with the corresponding embodiments.

The described embodiments may provide one or more advantages over conventional systems, devices, and, in general, solutions. A particular advantage may be provided when installing one or more taught information display device(s) in the context of hygienic service facilities. In particular, the user can interact with the information display device and control the content displayed or provide information without the need of touching the information display device or other parts of the hygienic service facility. At the same time, the embodiments can employ existing equipment in an advantageous manner: For example, the wide spread and availability of mobile devices (smartphones, etc.) and communication infrastructure (internet, cellular and wireless networks) can be employed to implement embodiments.

Although detailed embodiments have been described, these only serve to provide a better understanding of the invention defined by the independent claims, and are not to be seen as limiting.

1. An information display device comprising:
a display that displays content for conveying said content to a user; and
a receiver that receives data from a network,
wherein the information display device is configured:
to emit an optical signal;
to receive, from said network, a detection result indicating the detection of the signal by an external device; and
to adapt the content conveyed to said user by changing the content displayed on said display based on the received detection result.

2. The information display device according to claim 1, wherein said optical signal carries information for identifying the information display device.

3. The information display device according to claim 1, further configured to emit at least two different optical signals.

4. The information display device according to claim 3, further configured to display a plurality of patterns on said display by emitting said different optical signals.

5. The information display device according to claim 4, wherein said plurality of patterns include any one of a barcode, a two-dimensional barcode, a QR-code, a data matrix, a graphical pattern, a color pattern, or a timely varying pattern.

6. The information display device according to claim 1, further comprising at least two light sources, the information display device being further configured to emit said optical signals by the at least two light sources.

7. The information display device according to claim 6, wherein said at least two light sources each comprises a light emitting diode (LED).

8. The information display device according to claim 1, further configured to receive said detection result from a network entity over said network, wherein said external device conveys information indicating said detection result to said network entity.

9. An information display device comprising:
a display that displays content for conveying said content to a user; and
a detector that detects a visual, acoustic and/or gesture instruction from said user,
wherein the information display device configured:
to determine a detection result indicating an instruction from said user; and
to adapt the content conveyed to said user by changing the content displayed on said display based on the determined detection result.

10. The information display device according to claim 9, wherein said detector includes:
a camera to acquire an image of a visual or gesture instruction from the user; and
means for image recognition to determine said detection result.

11. The information display device according to claim 9, wherein said detector includes;
a motion sensor to acquire a gesture instruction from the user; and means for motion recognition to determine said detection result.

12. The information display device according to claim 9, wherein said detector includes:
a microphone to acquire an acoustic instruction from the user; and
means for sound recognition to determine said detection result.

13. The information display device according to claim 9, further comprising a receiver that receives data from a network.

14. The information display device according to claim 1, wherein said receiver comprises means for communicating with any one of the internet, a wireless local area network (WLAN), a local area network (LAN), or a cellular communication network.

15. The information display device according to claim 1, further configured to receive content to be conveyed to the user via the network.

16. The information display device according to claim 1, wherein the content comprises any one of audio, video, image, or text content.

17. The information display device according to claim 1, further comprising a control means for controlling and/or obtaining data from a hygienic service facility.

18. The information display device according to claim 17, wherein said hygienic service facility is any one of a toilet, a urinal, a sink, a dispenser, a towel dispenser, a toilet paper dispenser, a liquid dispenser, a soap dispenser, a dryer, or a trash can.

19. A system for conveying content to a user, comprising:
an information display device according to claim 8;
said network entity; and
said external device, wherein an application on said external device is configured to generate the detection result in response to detecting one of said signals and to forward said detection result to said network entity via a wireless communication network.

20. The system according to claim 19, wherein the network entity is configured to send information to the external device in response to receiving the detection result.

21. A method for displaying content for conveying said content to a user, the method comprising:
a step of emitting an optical signal from an information display device comprising a display - a step of receiving, from a network, a detection result indicating the detection of the signal by an external device; and
- a step of adapting the content conveyed to said user by changing the content displayed on said display means based on the received detection result. 87715198.1

22. A method for displaying content for conveying said content to a user, the method comprising:
a step of detecting a visual, acoustic and/or gesture instruction from said user;
a step of determining a detection result indicating said instruction from said user; and
a step of adapting the content conveyed to said user by changing the content displayed on said display based on the determined detection result.

23. (canceled)
